(19) United States
(12) Patent Application Publication
(10) Pub. No.: US 2002/0068585 A1
(43) Pub. Date: Jun. 6, 2002

(54) Intelligent mobile information system

(76) Inventors: Jawe Chan, San Jose, CA (US); Ting-Mao Chang, San Jose, CA (US)

Correspondence Address: Jawe Chan, 3072 Barons Court Way, San Jose, CA, 95132, US

(21) Appl. No.: 10/011,995

(22) Filed: Dec. 3, 2001

Related U.S. Application Data
(60) Provisional application No. 60/251,406, filed on Dec. 4, 2000.

(51) Int. Cl. H04Q 7/20

(52) U.S. Cl. 455/456; 455/414

(57) ABSTRACT

A system and method is to automatically search the required local information for the information user. It can use the information user's personal profile, position history, and query history to generate the next set of information user's required local information. The information search list can also be generated based on the information user profile. This local information accessing system and method will be very useful if the information user is mobile and do not have enough time to search the web.

### BACKGROUND—FIELD OF INVENTION

This invention relates to an information user profile building process. And the information user's profile can be further used to get more information for the information user.

The user profile includes information user's geographic position. The user's profile is then built for various purposes including the purpose of marketing survey. The system will send coupon, or any other information to the information user.

According to the information user's geographic position, the system will synthesis from the information user's geographic position taken by the Global Position System or wireless position system to a user's profile. This converting process also includes a privacy protection process to protect the geographic position information user's privacy.

It is especially important for mobile information device, like hand-held computer or mobile phone, with position detector device couple with it. The information user's profile can be automatic built and local portal information will then send it to the information user.

This invention is also an extent ion of the patent application Ser. No. US09/253931 and PCT/US00/03349. The information that the system is accessing includes information about information provider product and service promotion information, merchandise information, event information, weather information, news information, and information about people —personnel information.

### BACKGROUND —DESCRIPTION OF PRIOR ART

The mobile information processor, such as notebook computer, handheld computer, in-vehicle computer, electronic organizer, and personal data assistant (PDA), itself is a computer system and is able to process information. Each kind of mobile information processors has different capabilities and features for different purpose. Because of the mobile nature, user is not able to store large amount of information on the mobile information processor. User needs to connect to other system to access other information. Because of the mobile nature, the user will choose wireless connection to access the information on other system. The wireless connection capability on mobile information processor becomes important. Many mobile information processors have either an embedded wireless communication peripheral or an expansion slot for add-on wireless communication card.

Mobile communication device, like mobile phone or pager or Personal Digital Assistant (PDA), is a communication device with a small computer system embedded. The earlier mobile phone has limited capability to process information other than voice message. The earlier pager also is only able to receive the caller's phone number. However, the newer mobile phone and pager has much powerful processing unit and larger display to process and display extra information beyond voice message or phone number. Some of the new mobile device has the capability of voice recognition, web-enabled and larger display.

A mobile information device is mobile equipment that has both information processing and communication capabilities. Both mobile information processor and mobile communication device is mobile information device and eventually has both great processing and great communication capabilities and becomes little or no difference in the near future.

Internet is a revolution technology and contains the richest source of information. Through the Internet, user can access information on the world at the click of a mouse button. User can access information related to a company on the other side of earth at their home. Companies are promoting their product information and services or making direct sale on Internet. Internet is so powerful and convenient to store or retrieve information. Internet naturally becomes the best source of information for mobile information device.

The prior art used to deal with the explosive global information problem is to categorize the information. Most of the search engine on the Internet categorizes the information by the information characteristics. For example, Yahoo Company. Categorizes their database into automobile, travel, computer, political, stock quote, etc. User could choose the category to do the search. This approach might reduce the quantity of information return from a search. However, it is still too much and contains the global information within that category.

Some of company on the Internet further categorizes their information by the geography areas, for example countries or cities. With the geography area category, user could search the information only in a predefined area, which usually is a government district, for example ZIP code area, city, county, state, and country, etc. One of the examples is the Sidewalk WEB site of Microsoft Company. The WEB site provides a utility to locate the stores by given Boolean search criteria and an area, which could be a ZIP code, a city, a county, a state, and a country. After it found the stores, it returns a map and shows the store location by making a mark on the returned map. It has the disadvantage that the searching area is predefined user could not choose as they wish, for example to cross city limit or to narrow down to a shopping mall. Another disadvantage is the information is only limit to store location and without any merchandise information to help shopping. Some company —go2online.com, airflash.com, geeps.com, vicinity.com, savingumoney.com, timesthree.com, cell-loc.com, has recently tried to resolve some of the location-based issues that the industrial has. None of them develop a method for the information user to build the user profile by the history of the trace that was recorded from the information user's mobile device. None of them transfer “the history of the trace” to the “trace property”. The trace property is then used by the server system (center computer) to send the portal information to the information user according to information user's position. The portal information may include any knowledge base information, coupon information, sale information, event information, merchandise information, person information or any other type of information that the information user would like to receive.

Predefine search sequences to execute the predefined search criteria or search criteria list. So the information user will constantly get the updated information because of user location changes. This updated information may be local weather, local temperature, local merchandise, local store . . . etc. These location based company and organization —Go2online.com, airflash.com, geeps.com, atnotion.com, generalmagic.com, geoworks.com, cell-loc.com, timesthree.com, mapinfo.com, vindigo.com, lasoo.com, vicinity.com, locationforum.org provides the information user a steady search or provide the information user unconditional received the information from them. (These companies, some of them are broadcasting the advertisement.) These priors art basically are using the merchant as a center. Within that center range, the merchant broadcasting the advertisement or coupon or any product and services promoting material. The user is set up in a way to search and get the advertisement or coupon or any other information.

None of them develop a method for the user to access the information based on the user's “position pattern” or “position and shopping pattern”.

Another prior art that worth to mention is Global Position System (GPS) receiver. The Global Position System receiver receives the signals from several satellites and then determines its current position. The Global Position System receiver usually build-in a small computer. The computer has a display that could display a simplified map and show the current position on the map. The map is either pre-stored in the computer or could be down load from a remote site through a wireless connection. The computer uses the current position coordination to search a build-in database for local information, for example closest gas stations, hospitals, or restaurants. The build-in database is stored in a memory device of the computer, for example, flash memory or CD-ROM. It has the disadvantages that information might be out date and the searching area may not be selectable.

Some of the prior art such as the stock quote broadcasting through the web phone, pager. Or some of the prior art such as airline ticket availability broadcasting through the web phone, email, and pager. These types of the information searches are general a notification or event that notify the user.

A preliminary novelty search of classes 707/1, 701/213, 701/200 in U.S. patents, uncovered U.S. Pat. Nos. 586,799, 5,839,088, 5,802,492. However, none of the prior art shows that the search was triggered because of the user is triggered by user's location. And the search was also based on the shopping behavior or geography path of the user's location.

And the information search can be against information consumer specified searching criteria and searching area, and report the search results including information position through a communication link, such as Internet. Therefore, said information position is further used by routing or navigation application to provide information consumer driving guidance.

Advantages

Accordingly, besides the objects and advantages of the system and method for searching local information describes in my above patent, several objects and advantages of the present invention are:

(a) To provide the information to the information user according to the information user position.

(b) To provide the mobile information to the mobile information user according to the mobile information user's position history.

(c) To conclude the mobile information user's position history property. To send the information to the mobile information according to information user's position history property.

(d) To send the advertise information to the targeted customer by information user's position history information

(e) To provide mobile information user to formulate a predefine rules. The searches results will be output to the mobile information user by said predefine rules. Said predefine rules may be consist of time, geographic area, search pattern as elements of the predefined rules.

(i) To provide mobile information system to learn from the mobile information user behavior 1 and to search the information for the information user automatically. The information included information about product and service promotion information, event information (time related information), and personnel information.

### SUMMARY OF INVENTION

A fast and convenient local information search system and method is provided for mobile information device user who is able to search and efficiently retrieve the information corresponding to user's current location from Internet.

Normally the information user can get on the network by information user's first computer. The first computer can be a cell phone, a PDA, or a computer. The first computer will also be coupled a method to determine the first computer current position. The position is either be entered by the information user or a computer hardware mechanism such as wireless position system or a Global Position System. The information user's position is then send to a second computer, a server computer, through network. Once the server computer received the information user's current position, the server computer will couple the information user's current position and other criteria for further application indicated by the method below. Once the method is determined, the system will operate according to the method and send the results back to the information user. The following paragraph will determine the method may be used or the information database that will be searched by the information user.

The invention based on a local information system that is included 2 folds. One is information provider to provide information. Another one is the information user consumes information. Information provider provides information to the server computer by information provider computer. The information user consumes said provided information on the server computer through information user's computer.

Local Information System Contains

1. Hardware Connection and Apparatus

The position system used by this invention is not limited to any kind of coordinates systems. Can be cellular phone based position system, Global Position System or any other kind of position identifier system.

User of the preferred embodiment of the invention has a mobile information device that is able to process information and wirelessly communication with other computer system on the Internet. The mobile information device of the preferred embodiment of the invention is accessible to a Global Position System (GPS) receiver that is moving together with the user.

The other computer system of the preferred embodiment of the invention is a computer server. The computer server links to a database. The information in the database is organized according to the GPS coordinates of the information.

In the preferred embodiment of the invention, the user of mobile information device directly connects to an Internet Service Provider (ISP) wirelessly or to the mobile phone service company and then to an ISP through phone line. After connected to ISP, the mobile information device can communicate with any other computer system on Internet. Then, the user requests the other computer server on Internet to search information by providing the current and history of search criteria. The user could decide the number of history search criteria to be transmitting to the other computer server or automatically determine the number by user's current moving speed. The computer server searches the database according to the current search criteria and further filters out the search results that match with the history search criteria that are already transmitted back to the mobile device. The computer server will not record user's searching criteria history. Another method to transmit the current search criteria and history search criteria is to reorganize them into a new query with less information quantity but the same effect.

In another preferred embodiment of the invention, the computer server records the user's search criteria history. The user only transmits the current search criteria. The approach could further reduce the quantity of query information transmit to the computer server by increasing the working load of the computer server and manage a user profile for their history queries.

The search criteria are consisting of GPS coordinate, search radius, and information search criteria or any combination thereof. The GPS coordinate and the search radius define a search area. The information that matches the current information search criteria and locates within the current search area is a current candidate. The computer server further qualifies the current candidates by removing the candidates that were the candidates of previous search criteria. The final search result is much smaller and can be send back to the mobile device efficiently.

The preferred embodiment of the invention further proposed a prediction method to estimate the next information search turn-around time. With the prediction, user could determine the buffer time to allow other real time application to share the communication channel. With the technique, user could continuously do information search and prevent occupying the communication channel from executing other time critical task.

Another prediction method of the preferred embodiment of the invention is to utilize dynamic information, such as moving speed and direction, to determine the future searching geographic area and better query that reduce the redundant search results from previous queries.

The search results of the preferred embodiment of the present invention could be transmit back to the user in the order of the relative distance from the GPS coordinate of each search result to user's GPS coordinate. Since that, user could receive the closer and approaching information first and then far information.

2. Information Mention in this Invention

The information that information provider provides include the following information. The searching criteria mentioned in this pattern can also be the information criteria to search the following information.

1. product and service promotion information.

a. This includes coupon, shopping mall on sale information, the manufacturer rebate information, compare price information

b. Liquidation event, on line or off line (internet) auction information.

2. merchandise information

a. The system will be design in a way for the information user to enter a price range to search a specific merchandise item

b. The system will design to extract the shopping list from the information user's data base and automatic estimate the price for the information user. This will be acting like quotation system

c. Upon the system setting by the information user, the information system can further do the transaction for the information user and the merchandise can then send to the information user's location or his home.

3. event information

a. the event information can be movie or theater information.

i. The information user can enter time range or and the movie he want to go to. Once the criteria is enter, depend on the user's current location the search result will be retrieved. The results will be the nearby the information user.

ii. The event information normally is time related information.

iii. The event can be on sale event, movie event, birthday party event, a party event, a wedding event, sport event (basket ball, foot ball, tennis tournament, golf tournament, ski event, Olympic event.

4. Person information

a. The person information include a person's sex, character, salary, occupation, health information, blood type information.

b. The person information can be used for dating service to match 2 or more person. Once it match, the matched person can have a date

c. The person information can be used to find a job. This will be like a head hunter service. The job specific information matched to the information user's criteria the information user can used them to find a matched job.

d. If a person have a stoke, the system can search for nearby doctor. Upon retrieved the nearby doctor, the information user can call the doctor and ask for help. This way the person got the stoke can be taken care under a profession before the emergency crew come by

5. news or finances information

a. Local Stock market information.

b. Local finance news information

c. Local news information

Again, the data information was provided by information provider, the information user enter the information user data to the system. The user is then set up the rule to retrieve the information provider's information. The information user data can be information user's personal data include hobby, occupation, salary, shopping behavior database, information user geography path information or any other information related to the information user.

The information user can set up the rule about

1. How often can the information user retrieve the information from the server

2. What kind of information the information user would like to retrieve or access? Based on the information user's shopping behavior database or information user geography path information, or personal information that the information user is entered to the system

3. Information user can enter the geography search area criteria. The information user can enter within what radius the information user would like to search. Within one mile radius of the information user's position? Or 2 miles?

In another application, the local information search ability can be integrated with address book. When you click on the address book, the user can enter a search string about the neighbor. The store, the compare shopping, event shopping.

Local User Profile Building Process —Location Syntheses

Method 1 —Predefine Search Rules and Search Criteria (User profile was entered by user or default by system)

And said search criteria can also be a predefine search criteria. The search criteria consist of any following items —time, position ( or geography searching area), searching information criteria patterns.

Time is provided from the computer's local timer.

The position (or geography searching area) is provided from user's manually input or wireless location identifier or Global Position System Senor. The geography searching area can also be entered by the information user's pointing device. The pointing device can circle a geography searching area from a map on the computer's screen. Once the geography area is circled, the geography area will couple to the geography searching area criteria and become portion of the geography searching area criteria.

The searching information criteria patterns are provided from the computer application's software or web browser or web browser. The searching information criteria patterns can be price comparison patterns of the merchandise or matching with right person patterns, or matching with desire event patterns —party or any show or conference.

For example, the search results can also be automatically activated by the PDA (Personal Digital Assistant) or other computer device because of time and location.

The information user is then enters a set of user profile database with a set of the rule for the information user to retrieve the information. These rules are related to the information user's position. When the information user is on the move, the information user will retrieve the information user based on rule set up by the information user. The user profile database can be information user's shopping behavior model, or geography tracking path information or information that the information manually enter to the server computer system.

For example, if the local information user choose to find

1. on sale shoes

2. on sale computer items.

3. on sale piano.

Each item will have its own rule. Rule for searching —on sales shoes will be associated to the user profile item number 1. Rule for searching —on sale computer items will be associated to the user profile item number 2 Rule for searching —on sale piano will be associated to the user profile item number 3.

The system will generate the search results to the information user based on the data and the rules. Depends on the rules that the information user defines. The search can be generated automatically and the search result can also be return automatically. The geography location of search results can be within a geography area that the information user is in. The system can further assist the information user to the search result location.

The information search system can be further integrated with payment system or account system or a billing system or a quotation system.

The information user can define the following condition for his or her needs. Ex. If the information user gets in his or her garage from 8:30 to 9:30AM, the PDA will automatic search for the weather information around this city. If the weather is below normal temperature, the PDA will send an alert signal to the information user. The information user can then change his cloth or bring an umbrella. After the information user on the way to work, the PDA will then search for a location for a MOCA coffee with a better price automatically. (Information user can try different place for a cup of coffee from time to time). Once the search schedule is set the information user will search for

a. Local weather information from 8:30 to 9:30AM workday, when the information user is in the garage. (GPS can sense the location of the user and report the local weather, So the weather report will also be local first)

b. Cup of coffee information from 8:30 to 10:00AM workday when the information user is on the way to office.

Further more, the PDA can allow the information user to set an alert system. Ex. When the weather is approaching record high (A history temperature data for specific date) within 3 degree C., the PDA or cellular phone will vibrate or ringing or any other form of notification the information user to add more clothes or prepare for the weather. (The information user does not need to know about the weather if the weather is normal or within the condition that the information user is set saving user time) Even with the information user travel from places to places, the PDA with GPS will always report or search according to the local weather condition. The information related to the harsh weather changes will be display in the PDA or cellular/web phone. This information can be

How to drive in the cold weather (If the weather happen to be cold)

How to prevent sun burn when in the hot weather?

How to prepare the clothes due to the day and night temperature changes more than 30 degree C.?

In this case the data is the information user's location and the rules is reporting the weather related information back to the information user.

One more example, when the information user is traveling, the information can has the following predefine searching criteria

Search for food store when it is between 11:00AM to 1:00PM. Will stop the search when the PDA is in side a food store for more than 15:00 minutes.

Search the kind of food other than last meal. By the location and time, the computer will automatic determine the last kind of meal you ate.

Search for cheap gasoline price station when the gas line less than one fourth of the gas tank

Search for tourist spot when entering a sight seeing area.

This will be all done by a predefine search criteria. The information user can maintained a predefine search criteria for easy access information. (Hand free environment)

Method 2 —User Profile Was Built Upon the Trace History

The information user position history information can be used by the system to summarize the information user's activity. This is how it works.

The database couple to the server computer is included a business name and a position coordinate of said business name. The business name was categorized in a directory structure like a yellow page. For example, Red Lobster is categorized as a restaurant and under the restaurant category. If the Red Lobster has multiple of branches, the Red Lobster restaurant will be associated multiple position coordinates depend on where the branch is located.

In the prior art, the information user will search for the name of the business and information system will then return the coordinate of the searched business name. In the present invention, the information user will get the business name and the directory category structure of the business name from the position coordinate of the information user. The position coordinate of the information user is transferred from the GPS or wireless position system that coupled to the information user's PDA or cell phone or any other computer that the information user is carried.

Example of Database structure:

Business₁₃ catergory—>business₁₃ name—>business₁₃ position₁₃ area

For Red Lobster restaurant will be

Restaurant—>Red₁₃ Lobster—>longitude₁₃ range₁₃ latitude₁₃ range

Following is the system in action example. Every day the information user can go to a lot of places. (Position coordinates will be recorded by the cell phone or PDA through the GPS system couple to the PDA or cell phone) The time (when) and the duration that the information user spends on each position can also be recorded. If every time the information user spends more than 30 minutes, the system marks the place as a favorite spot. These coordinates of the favorite spots and the time (when) that information user was in the favorite spot can be sent back to the system. The system is then determined the information user is in a Red Lobster. And the Red Lobster is a restaurant. (Business₁₃ catergory/business₁₃ name). These property convert process can be real time or can be a batch mode process.

So, this name of location and the type of location, information property, is then taken by the system. Latter on the system will send the related information —product promotion information or any other news information to the information user. Ex. If the location happen to be a sport club, the system will send sport related news, coupon, or any other information to the information user. The method is called location syntheses. This way the information flow will be totally automatic learn by the system for the benefit of the information user. In this case, the information user can build up a syntheses database about the home activity. This syntheses database is a profile about what kind of places the information user will go to. If the syntheses database is a supermarket, computer store, shopping mall, sport club. When the information user travel to other places, the information user can ask the system to locate the similar places that the information user normally go to by the syntheses database. The system will locate nearby supermarket, computer store, shopping mall and sport club for the information user. The information user will be familiar the new location right away. (It feels like home or may be the new location will be a lot better than home due to there is more favorite places in new location)

For a normal location based database, there is a map information and a product or service information associate with it. The product or service information database normally is a store location database. From there the information user can enter the search criteria to search the nearby store location. Normally, the user location will feed back to the server computer and to form a geography search area. This search area with the search criteria will return the search result back to the information user. The search result normally contains the location information of the store.

This way when the user step into a store, the system will know the duration of the information user stay in the store. (he system can pick up the information user position every 5 minutes) Once the position history data is collected. The position history data will be process and to find out what kind of the store that the information user is staying. The chacteristics of the store can be determined due to the store database is built by the characteristics. Once the characteristics is determined, the system can send any other information to the information user to help information user to carry out the activity while the information user is in that location. The can be done by automatically.

Following is the method to let the information user has the privacy that he wants about his positions history. The information user can login to the system by his user id and password. When the information user send the position coordinate from his Global Position System or wireless position system to the property server, the property server will only record the IP address and the information user's position. The information user's position coordinates will then be transferred to a property. This property can be the information user's favorite sport, favorite type of restaurant, favorite type of supermarket, favorite type of furniture store, or favorite type of hobby. This property information will then send back from the property server back to the information user's PDA or cell phone. The information user can send the property information to match server immediately from the PDA or cell phone or wait until the information user collect enough volume of user's property information. This information user's property information will be transferred and become information user's profile on the match server. This way information user's position history will be kept in privacy and the property server or match server do not have a copy of information user's position history. The only thing can be back trace is the information user's profile which is the property information extract from the position history.

The match server will send the coupon, or hobby portal according to the information user's profile. This information user's profile can be entered by information user from a web page or from this above automatic method. The server system will never know or record the information user's position history. The server system only records the information user's profile information. The user's profile information will used for the system to send the following information to the information user including product promotion information, news information, merchandise information, event information, people information of near by location.

Information user can also synthesis some of the geography location that information user input. The might include information user's friend home, boss home, business partner's home or office. This information is normally store in the PDA or Personal organizer. If the information user has physically in location that the information user stored in the any location personal organizer, the system will determine the information user have good relationship with that person. The system will send an alert message to the information user, when the visited person birthday or any other personal occasion.

Another integration method is to get the user profile data from the cell phone data base received.

Lately, the wireless web enabled phone can be used by the information user as a method of paying the bill instead of paying on the cashier machine in a local store. So, the “receive database” can be further used by the system. The system will know when, what items, how much money the information user has spent. This information can be used in several way.

1). The routine trace database and the receive database can be mixed.

If the information user is often buying computers, the system will used the computer as a merchandise item to search around the information user's activities area. The activities area for the information user is constructed from the information user's GPS trace record and the its neighborhood (the area 2 or 3 block away from trace record=>this can be define by the system or information user). The system is then search the computer item or any computer promotion (Counpon, sale information, discount information) The return information will show up when the information user pass by the area. This will be a method to alter the information user normal caused.

2). The information user can review the search results. This result can be store as a schedule item on information user's Microsoft outlook. This way the information user can spend sometime with some meaningful information.

3). After the information user spend some time on the returned searched results. The information user can check several store location or point of interests. When the information user pass through the location, the system will remind the information user to drop by the point of the interests or the store to check them out.

Once the item being identified, the system will identified the information user's regular path.

The information user's trace information that the Automatic Location Identifier (GPS or wireless location identifier —this can be deploy by the network-based positioning technology, hand set based positioning technology, or their combination) keeps updating contains of coordinates information and duration information. This information keep in the user's computer (Cell phone or PDA). The coordinates can send to the server computer to get the property back to the information user's computer (Cell phone or PDA). These property is then combine with time to form a complete property information (user profile information) to send to the server and for used by the server. The server computer will ask the information user to set up the information user account. According to the account set up, the system can send the product promotion information to the information user.

If the user want to receive product promoting information according to the end user's location property or property behavior.

The system can setup a geographic range for the information user. Once the information user is step into to the zone, the cell phone will dial up and get the information (product promoting information etc) to the information user to alter the information user route and increasing the foot traffic for the information promoter. The information user's cell phone or PDA can also accumulate the connection time that was consumed by this information access purpose.

This is the information user that it can be used for the rest of the data.

In the prior art, WO 00/49530 mobile information service is dedicated focus on the location of interested in. When the location user approach the desire location selected by the information user, the system will send the information back to the information user. In present invention, the system will know the information user desired location in term of coordinates or positions. The system will know the information user is in a restaurant or cash dispenser or any point of interests. The system will send the product promotion information about other location with same type or service.

Local Information Retrieving System based on user profile

Once the local user profile is built, the system can send the information to the local user based on the user profile. The information can be send by email, by phone, by voice mail, or store on the internet or poping up a information window once the local information user log on the internet or the website.

Another examples.

If a user went to an open house, the user's cell phone with GPS function or other positioning method can record his position. This house happens to be 3 bedrooms and 5 years old. The system will based on this criteria search for near by house with 3 bed room and 5 to 10 years old house.

This process is called activity converting process. And here are the steps

1. The server will create a user profile based on the user's location history. The user profile can contain but not limit to —how long the user is in where.

2. The activity list will be created. It can be created by the user manual input or by the server based on position history of the user from the users cell phone automatically. In this case it is the buying house process.

3. Based on the activity list and user profile, the user can get the more information about his/her future activity. The information will send to the user just like the user on the internet searching for information to buy a house. The system will notify the user wherever and whenever there is a house match his or her criteria.

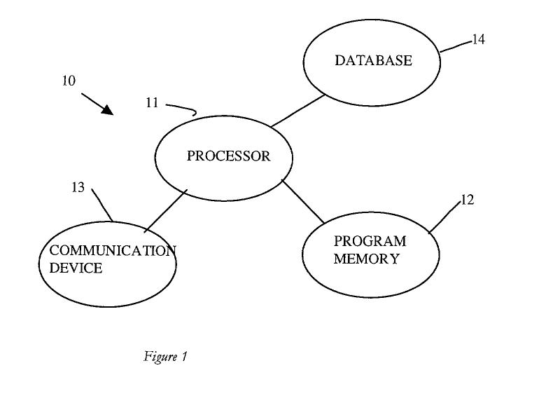

### DESCRIPTION —FIGS. 1 to 10

FIG. 1 illustrates an example of a server computer system 10 for storing and retrieving merchandise data in accordance with the invention. Computer system 10 comprises a processor 11, program memory 12, a communication device 13, and a merchandise database 14. The communication device 14 might be a modem or a high-speed leased line router. In the embodiment of FIG. 1, system 10 is an information server, and processor 11 is in data communication with the various end-user computer systems via the Internet. However, in other embodiments, the invention could be implemented with a processor having multiple modems to receive calls directly from enduser computer systems and establish the data communication via the modems and public phone line.

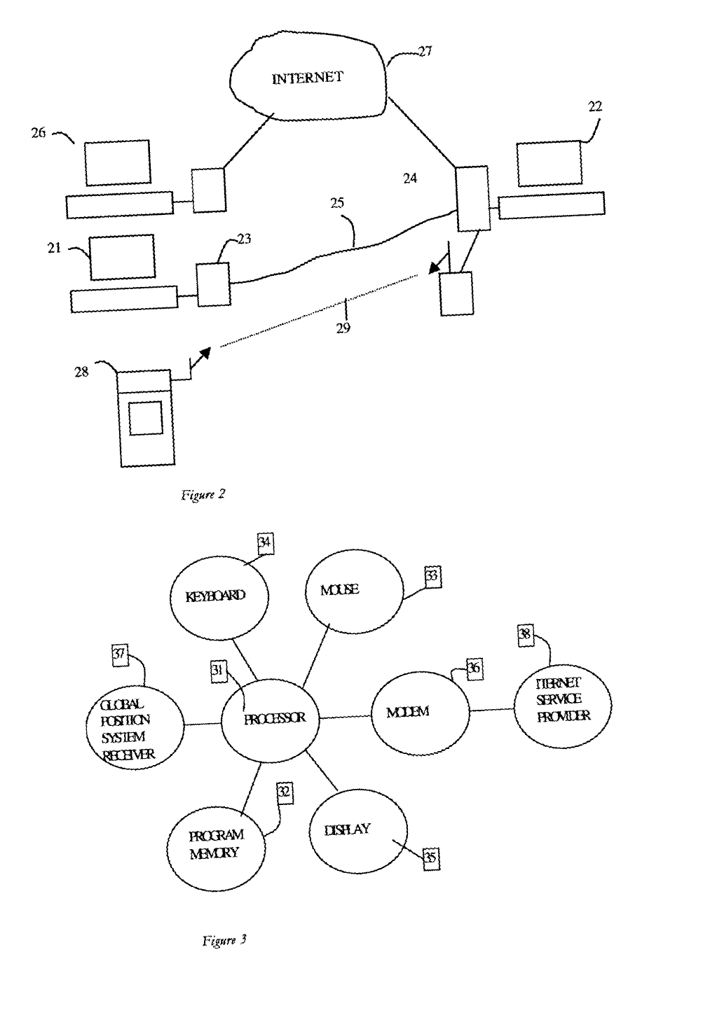

In FIG.2, it shows end-user computers communicate with server computer in variety ways. End-user computer system 21 connects to server computer system 22 via modem 23 and modem 24 through phone line 25. Another example is that end-user computer system 26 also connected to server computer system 22 through Internet 27. End-user computer system 28 connects to server computer system 22 through radio frequency link 29.

An example of a suitable computer system 10 is one operating in accordance with the Sun MicroSystems Solaris operating system. Processor 11 may be any general-purpose processor having a CPU, RAM, ROM, and I/O circuitry.

To explain further, one aspect of the invention is the use of computer system 10 to access product promotion information (e-coupon, coupon or product sales event) and business directory information database 14 to provide a user with product promotion information (e-coupon, coupon or product sales event) within a given area by the user's path history. In the example of this description, database 14 is a centralized database system and stores the data about product promotion information (e-coupon, coupon or product sales event) and business directory information in the worldwide area. However, in other embodiments, database 14 might be implemented as a distributed database system, which stores the information in several computer systems and might locate in different areas. Each of distributed databases might store data about merchandise information in a local area, such as a particular state or country.

Database 14 of the embodiment is implemented in a relational database manner. Each of product promotion information (e-coupon, coupon or product sales event) and business directory information is organized as a record in the database to describe a merchandise, having a filed for each product promotion information (e-coupon, coupon or product sales event) and business directory information record to describe the merchandise, for searching of records of product promotion information (e-coupon, coupon or product sales event) and business directory information describing that product promotion information. Another field in each of product promotion information (e-coupon, coupon or product sales event) record is a position field. The position field is a position coordination of the merchandise. The position coordination is comprised of latitude and longitude of Global Position System coordination. It could also contain altitude of Global Position System coordination when it is necessary. The database 14 could also be arranged in an object-oriented manner for attribute searching.

FIG. 3 illustrates an example of an end-user computer system 30 for retrieving merchandise information in accordance with the invention. Computer system 30 comprises a processor 31, program memory 32, a mouse 33 and keyboard 34 for user input, a display 35, a modem 36, Global Position System receiver 37, and Internet Service Provider (ISP) 38. In the embodiment of FIG. 2, system 30 is an end-user computer system, and processor 11 is in data communication with an Internet Service Provider 38 first and then the Internet Service Provider transmits the data to the computer system in FIG. 1 via the Internet. However, in other embodiments, the invention could be implemented with a processor having a modem call directly to the computer systems in FIG. 1 and establish the data communication link via the modems. Or, the invention could be implemented such that the end-user computer system in FIG.2 and server computer system in FIG.1 is in a local network (LAN) or a wide area network (WAN).

In the embodiment of FIG. 2, Global Position System receiver 37 is a positioning instrument, and is used as current position coordination input device for computer system 30 in FIG. 2. However, in other embodiment, user of computer system 30 could input the position coordination from other input device, for example from a keyboard 34, if the user knows his or her current position or like to search merchandise information at other location.

An example of a suitable end-user computer system 30 is one operating in accordance with the Microsoft WINDOWS operating system. Processor 11 may be any general-purpose processor having a CPU, RAM, ROM, and I/O circuitry. Other input devices instead of, or in addition to, mouse 33 and keyboard 34 could be used, such as trackballs, touch pads, graphic tablet, or joysticks. The processor 11 is programmed to execute a process to help the user and take user's input.

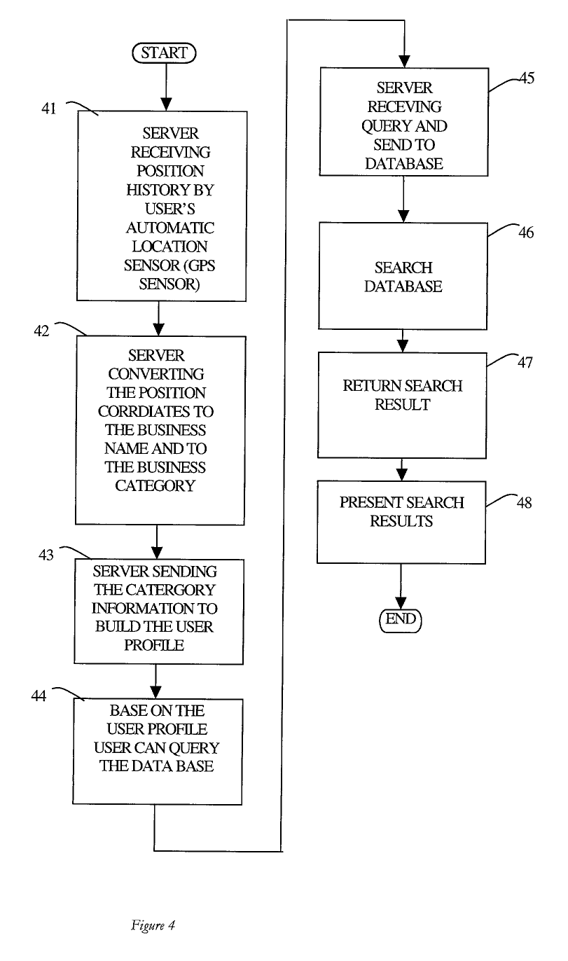

FIG.4 illustrates the flow chart of the location trace was used by the system when the user doing or receiving information from the databse.

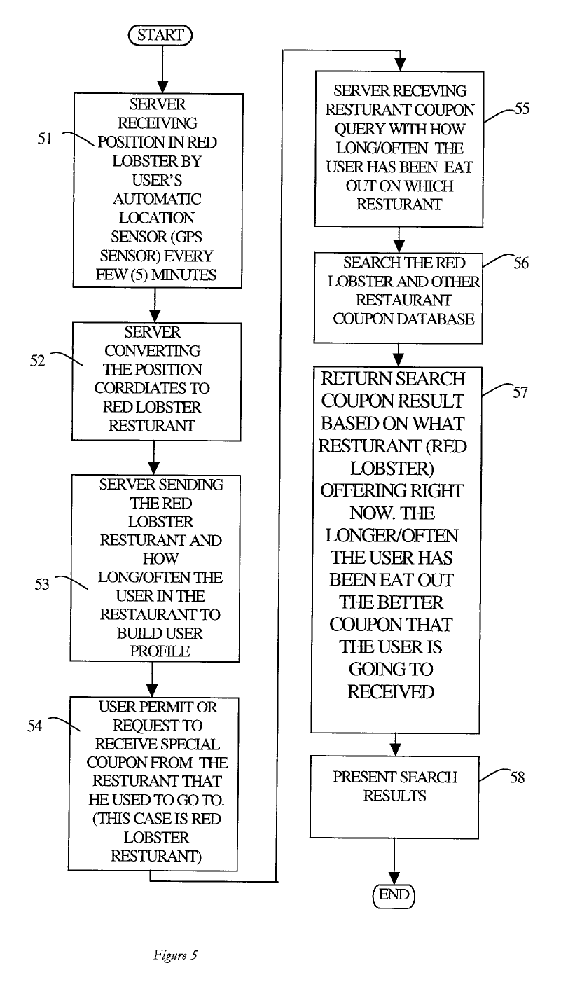

FIG.5 illustrates the flow chart of the location trace was used by the system for coupon purpose. The return coupon result can come with each coupon location. So the user can go the nearby restaurant coupon location.

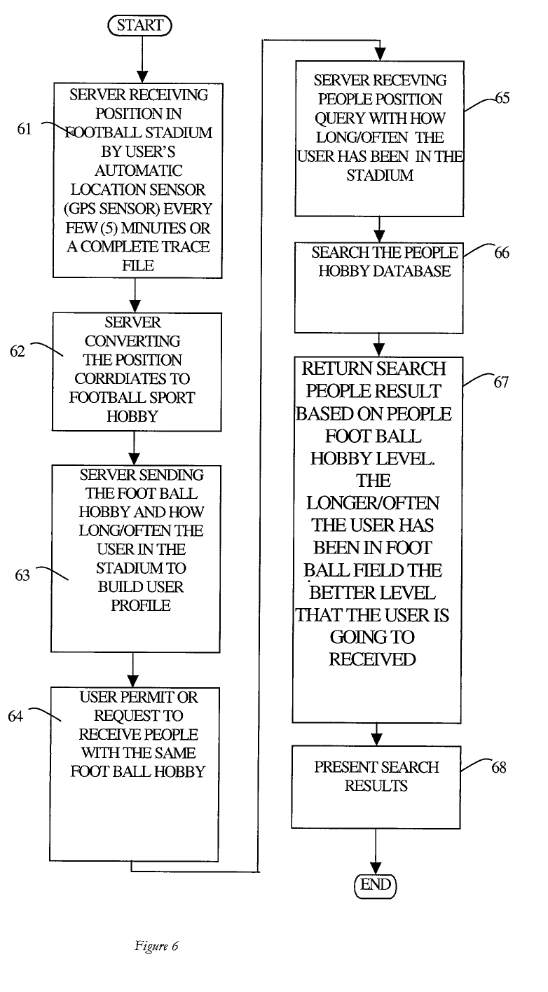

FIG.6 illustrates the flow chart of the location trace was used by the system for people community (hobby) building purpose.

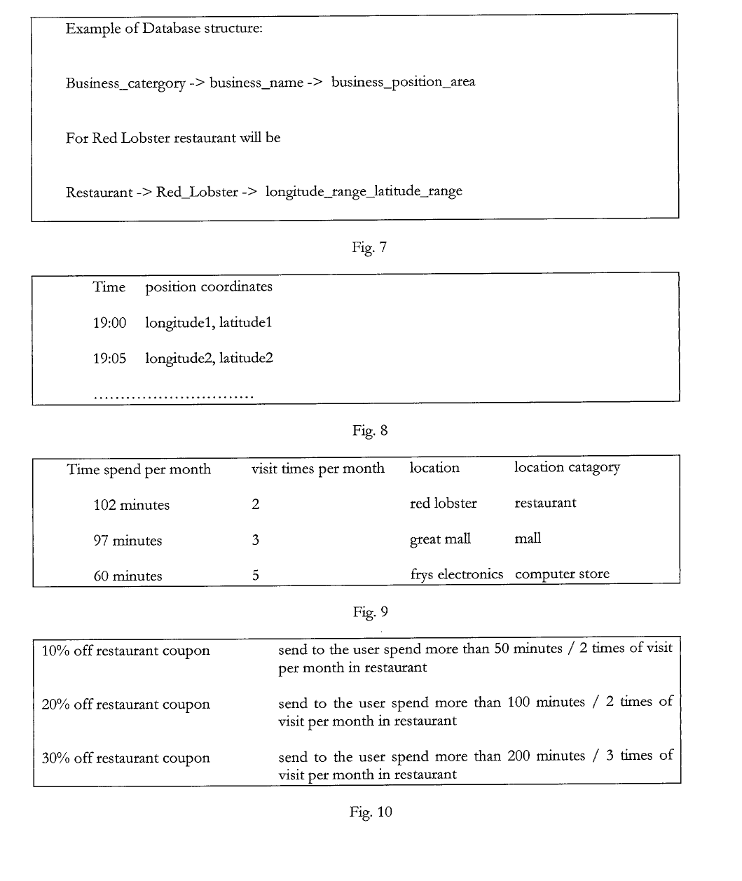

FIG. 7 Example of Database structure:

FIG. 8 is the database —user profile database build in the user's computer. Example, every 5 minutes, the computer will received position coordinates from user's location sensor (GPS sensor).

FIG. 9 is the file converted from server's CGI program. This file can be converted locally in the user's computer when the user's computer gets on line (internet). Or this file can be send to server and server will send back to user's computer the converted file in FIG. 9. This file will be the user's trace profile. This file can be deleted from the server computer to protect the user's privacy.

FIG. 10 is condition of the coupon that will send to the user base on the user trace profile.

### Conclusion, Ramifications, and Scope

And the information user's profile can be further used to get more information for the information user.

The user profile includes information user's geographic position. The user's profile is than built for various purposes including the purpose of marketing survey. The system will send coupon, or any other information-to-information user.

According to the information user's geographic position, the system will synthesis from the information user's geographic position taken by the Global Position System or wireless position system to a user's profile. This converting process also includes a privacy protection process to protect the geographic position information user's privacy.

It is especially important for mobile information device, like hand-held computer or mobile phone, with position detector device couple with it. The information user's profile can be automatic built and local portal information will then send it to the information user.

Thus the scope of the invention should be determined by the appended claims and their legal equivalents, rather than by the examples given.

We claim,

1. A method for a computing device to interact with a user, the method comprising:
receiving position coordinates relating to said computing device;
processing said position coordinates to return one or more properties; and
building user profile relating to said one or more properties.

2. The method of claim 1, further comprising:
searching process relating to a search object based on said user profile.
